(19) United States
(12) Patent Application Publication
(10) Pub. No.: US 2015/0294245 A1
(43) Pub. Date: Oct. 15, 2015

(54) METHOD AND SYSTEM FOR HANDLING PROGRAM, PROJECT AND ASSET SCHEDULING MANAGEMENT WITH RESERVES MANAGEMENT AND APPLICATION INTEGRATION

(71) Applicants: Ajay R Nagar, Katy, TX (US); Anouar Jamoussi, Sugar Land, TX (US)

(72) Inventors: Ajay R Nagar, Katy, TX (US); Anouar Jamoussi, Sugar Land, TX (US)

(21) Appl. No.: 14/251,835

(22) Filed: Apr. 14, 2014

(51) Int. Cl. G06Q 10/06; G06Q 40/00

(52) U.S. Cl. CPC G06Q 10/063; G06Q 10/0635; G06Q 10/0633; G06Q 40/12

(57) ABSTRACT

The invention comprises management of integration with interfacing applications, with emphasis on configurable database connectivity, logic manipulation of data, error checking with correction capability, with or without conditional criteria through a Graphical User Interface. The data can further be configured to be transported directly or through user-controlled means that allows manual modifications. The system mines the original and modified data with timestamp, history and audit trail that can generate audit-related information any time in the future. It further provides a hierarchical roll up and breakdown capability of managing reserves assets. Approval, Action Item, document attaching, notification and instant messaging functions can be linked to the integral functions. Status, history, audit trail, reports and statistics are tracked, maintained and linked to each element of the data and its related function, and this information is producible in any statistical, graphical or textual format.

### BACKGROUND OF THE INVENTION

1. Related Applications

This patent application claims priority to and the benefit of U.S Patent Application Ser. No. 13/338,559 filed on Dec. 28, 2011, titled “ Method and System for Handling Program, Project and Asset Scheduling Management”, incorporated herein by reference in its entirety.

2. Field of Invention

This present invention pertains to a computerized method and software system for automating manual processes for handling data importing and exporting, user and non-user configuration of data manipulation and error checking, and data mining with audit tracking capability that can be applied to interface connectivity, reserves, finance, program/project as well as any operational, Information Technology (IT) and administration management of data. The invention can co-exist and embedded with into very large programs (comprising of a nested hierarchy of projects) to small projects to, including tracking and reporting of all pertinent governance-related activities, documents, assets and resources.

3. Description of Related Art

The economic growth in the last decade combined with globalization has resulted in a huge increase in large and colossal initiatives and their activities are spread across borders and continents. Companies large and small in every industry implements a mix of software applications from many different software vendors as well as home-grown customer applications. Integrating many-to-many applications and systems is a very complex, time consuming and laborious effort that requires extensive program coding. This is further complicated when the supporting applications manage financial, reserves and program/project related activities that are crucial to maintain the health as well as longevity of the companies. Effectively coding programmatically and maintaining the code for handling a multitude of interface integrations across many applications is extremely time consuming, requires specialized programming skilled resources, very expensive and error-prone.

In addition, effective management of large and small programs, projects, finance and reserves such as oil and gas reserves in conjunction with forecasting and economics, interface integration with configurable database connection, data manipulation through configurable logic, data mining and archiving historical data is extremely beneficial and overdue in terms of the overall demands due to an exponential growth of economic and industrial activities in these areas all over the world. These functions can be interlinked with other supporting functions such as scope, effort, budget, asset and people resource management and scheduling, risk, collaboration, day-to-day-activities, status and progress tracking The end-to-end capability of enabling data flow from system to system, function to function, and application to application will increase efficiency, productivity, data integrity, data availability and decrease operational costs at every level of an organization that is currently challenging to arena.

Managing a wide variety of different business, operational and administration functions within large corporations that have subsidiaries, divisions, departments, teams and initiatives is challenging in many aspects. Various patents and patent applications propose point solutions that handle one or the other in specialized business applications but not in collection of all functions across all applications, irrespective of their core functionality. These methods require extensive external integration to interface the applications, prevent cross-transparency, lack direct cross-connectivity, and require prolonged implementation time and cost to conjoin any two disparate applications. Various patents and patent applications propose point solutions for a specific function area. U.S. Pat. No. 8,689,096 issued to Bross et al. and incorporated by reference in its entirety for all purposes, is directed at completing missing data needed in a tax based application. Quoting its abstract “A computer-based method is used for completing missing data need in a transaction-tax-related application, where the method uses completing rules that define, depending on which missing data needs to be completed, what further data might be considered for deriving the missing data. A completing rule associated with the missing data is evaluated, and an auto-completion certainty parameter is determined as a result of the completing rule evaluation. Completed data is derived accounting to the certainty parameter”.

Existing patents and solutions are geared towards very specialized use cases or a very finite activity. User configurable logic management that can be applied universally to any-to-any application integration is lacking in the industry. Logic management is predominantly handled through hardware devices that utilize digital, analog and other devices or in the case of software, directed at a specific set of rules or configurable. Companies incur huge costs in trying to bring integration of multiple applications, data manipulation through configurable logic, mining, restoring and providing data transparency speedily, and linking these capabilities holistically to a collection of business, operational and administrative functions is not available. U.S. Pat. No. 8,689,184 issued to Aaron et al. the Aaron patent describes “An apparatus, system, and computer-implemented method of managing a software program. The computer comprises a processor, a memory, and an input/output interface for receiving and transmitting information to and from the processor, the computer providing a development environment for developing a set of instructions executable by a system. The processor receives a first program containing information in machine-readable form. The information represents a first set of instructions executable by the system. A configuration is created for the system based on the received information. The processor generates a second program containing a second set of instructions executable by the system based on the configuration. The second set of instructions corresponds to at least one algorithm assembled in a nested hierarchy”.

Problems remain in handling cohesively many-to-many application integrations, managing data inflows and outflows through user- defined rules for each integration that can be independent of one another, providing capability to multiplex the imported data through one of the flow combination such as direct flow without user intervention, flow with user intervention that controls the outflowing data through a commit-release workflow, enabling automatic data manipulation of incoming data through user-configured rules, enabling automatic error-checking of incoming data through user-configured rules, as well as enabling all these to the already received data prior to releasing it to the peripheral applications and business functions that need that data.

An automated hierarchical structure that can perform roll up calculations and roll down (breaking down) of assets such as oil and gas reserves and reflect dynamic calculations of capacity (that is, volume), revenue, cost of producing and income is currently lacking Oil and gas companies own hundreds of thousands of wells each of which has several completions (well bore) that hold the assets (oil, gas, commodity residue) in thousands, millions and billions of BOE (Barrel Of Oil Equivalent). These wells are physically located in a land or subsea parcel referred to “Lease”. Tens, hundreds and thousands of leases may be grouped under an owning Reservoirs or Field which are consolidated under several Business Units of a company, and these Business Units are consolidated in a central managing Business Unit in a company that is responsible for maintaining the financial interest, health, asset (how much each lease, well, completion has BOE available in ground versus what is already produced) and responsible for adherence to the regulatory and reporting requirements. An asset can be excluded or included to the reserves and finance calculations by removing it or adding its volume and/or monetary values. The company's financial health is also dependent on accurately determining how much of these assets area already produced and sold, cost of producing these assets, revenue generated, and how much remains in the ground or below seabed that is available to use in the future years. Most related companies manage this complicated process through a collection of spreadsheets and other home developed utilities. The output data is then fed into the company's financial applications through a tedious, all year long manual effort.

### SUMMARY OF INVENTION

Other objects and advantages of the present invention will become apparent from the following descriptions, taken in connection with the accompanying drawings, wherein, by way of illustration and example, an embodiment of the present invention is disclosed.

The present invention provides a system to create structure of multiple tiers of entity nested nodes that will enable management of these entities. These entities can be representative of a mega program/program/project/activities structure, groupings of applications being integrated, business organization structure such as business units, divisions, departments, reserves related entities such as owning business units, field, lease, well, completion structure etc. Each node within the tree can have multiple nested nodes that will allow it to maintain a parent-children relationship through a multi-tiered structure.

The present invention provides the means to define connectivity parameters of an external interfacing application or its own internal schema through a universal user interface configuration means. The ability to configure this can be linked to any entity node in the hierarchy tree which then allows an independent configuration of that node, which can be the external application or an external/internal function. This method allows the system to both receive data from and send data to a multitude of external interfacing applications and internal or external functions.

The present invention provides the means to load (that is, import) and send (that is, export) data through an ad hoc means as well as by scheduling that can be set to recur every preset time, day, date in a variety of frequencies. Each option is linked to the entity node in the hierarchical tree that allows that node to import and export data independently of one another.

The present invention provides the means to manipulate automatically the data that is imported from external systems, or generated by the same system, or exported to the external or same system by enabling the creation of rules to apply logic and arithmetic algorithms so that a new set of values can be generated and retained for the incoming or outgoing data. The imported data may contain one or many types of data attributes. Rules can be set dynamically (that is, as needed) or statically (preset ahead of time). The rule allows selection of a condition or criterion such as for an Attribute A, for its values between 1,000 and 2,000, change the value of Attribute B by taking its original value, multiplying to say, number 10, and retaining this new value for Attribute B. Similarly, any Boolean logic or mathematical operand can be used to derive the new value(s), or a totally new single value applied globally to the defined existing Attribute(s), or generating new Attributes. This method can be applied to the future import data as well as the data that is already imported.

The present invention further provides logic and arithmetic algorithm application across data imports of different interfacing systems or generated by different functions within the same system. Rules can be set dynamically (that is, as needed) or statically (preset ahead of time). The rule allows selection of a condition or criterion such for an Attribute A from Interface or function 1, for all its values between 1,000 and 2,000, change the values of Attribute C from Interface or Function 2, by taking C's original value and multiplying it by a factor of n. Similarly, any Boolean logic or mathematical operand can be used to derive the new value(s), or a totally new single value applied globally to the defined existing Attribute(s) or generating new Attributes. These rules can be applied to the future import data as well as the data that is already imported.

The present invention provides means to perform an error or certainty checking with or without conditional criteria on the data that is imported from external systems, or generated by the same system, or exported to the external and internal systems. Rules can be set dynamically (that is, as needed) or statically (preset ahead of time). The rule allows selection of a condition or criteria such for an Attribute A from Interface or Function 1, for all its values between 1,000 and 2,000, check for null or blank value, and either replace the blank or null with a new value, and/or report the errors and the modifications performed. These rules can be applied to the future import data as well as the data that is already imported.

The present invention provides means to combine data manipulation and error/certainty checking on the same imported data as well data to be exported out of the system.

The present invention provides the means to manage the data imported from external systems or internal functions through a “Manage Data-Commit-Release” workflow means. The data can be further manipulated automatically through logic manipulation expressions or manual updates, such as via User Interface facility. The data can be allowed to flow freely to the receiving functions and systems or controlled by a person who enables the flow through a commit and release means.

The present invention provides the means to perform arithmetic and Boolean algorithms to any entities within or outside of the hierarchical trees, and roll up or roll down the values that can be a total sum, average or as established by the algorithm. It also allows entering a new value by overriding the original value and coming up with new roll up, or roll down (breaking it up) values as the summation occurs across a multitude of entities within a parent node. This is repeated at each level of the node from the lowest node all the way to the top node where a single set of summation will be delivered from thousands of individual entity values within the nested hierarchy.

The present invention provides the means to track documentation that can be free-text entered by a person or attaching a document.

The present invention provides the means to track the audit trail of all the modifications in the system to the data, timestamp, person making the change, and the resulting new data.

The present invention provides the means to save, store, archive and restore the original and modified data and enable data mining. Each instance of the data is time-stamped and linked with audit trail information that when restored any time in the future can provide details of when the original data was loaded, its source such as an external interface or the internal system function, the original value, what operation was performed such as error checking with correction, logic manipulation, user modification, the credentials of the owning person or system with respective identification and timestamp.

The present invention additionally provides the means to track approvals, action items, meeting minutes and decisions, look ahead capability and attachment association, with each function supporting workflow capability that enable actions to be invoked based on the condition set, and providing its progress status, warning indicators and other pertinent information. Each function can be invoked from every node and its related information is linked and localized to that node for speedy reproduction of the localized data that is relevant to the node. The collection of these functions provides governance capability for each node's activity.

The present invention can interface with any other system to import data that can be used as an input to the system's functions, or export data of its functions and nodes to other systems.

The present invention constructs statistical, graphical and other format reports by combining any data of the available functions within the system or that received from external systems in any acceptable format. These can be linked to every entity in the hierarchical tree.

### BRIEF DESCRIPTION OF DRAWINGS

The accompanying drawings, which are included to provide further understanding of the invention and are incorporated in and constitute a part of this specification, illustrate embodiments of the invention. Understanding that these drawings depict only typical embodiments of the invention and are not therefore to be considered limiting of its scope. In the drawings

FIG. 1 illustrates an embodiment of the invention to enable configuration of a database or a file source within the same or different system to receive or extract data from through a Graphical User Interface (GUI).

FIG. 2 illustrates an embodiment of the invention to enable configuration of a database or a file source within the same or different system to send data to through a Graphical User Interface (GUI).

FIG. 3 illustrates an Embodiment of the Invention to enable ad hoc and scheduled import and export of data from and to other systems respectively.

FIG. 4 illustrates an embodiment of the invention to enable logic manipulation of the imported or to-be-exported data through a Graphical User Interface.

FIG. 5 illustrates an embodiment of the invention to enable conditional and unconditional error checking and error correction through a graphical user interface.

FIG. 6 illustrates an embodiment of the invention that enables organization and roll up, roll down calculations in a hierarchy based on different algorithmic criteria for reserves.

FIG. 7 illustrates an embodiment of the invention to enable calculations pertinent to a reserves asset that can be linked to an entity within a hierarchy.

FIG. 8 illustrates an embodiment of the invention to enable management of inflowing data that can be error checked with corrective actions or manipulated through configurable logic or manually, with the original and modified data stored so it can be reproduced with the audit history information any time in the future.

FIG. 9 illustrates an embodiment of the invention to enable management of inflowing and outflowing data with links to operations, logic, error checking, approval, document attachment, action item, notification and instant messaging functions within the host and external systems and processes.

### DETAILED DESCRIPTION OF INVENTION

The present invention will now be described more fully hereinafter with reference to the accompanying drawings in which embodiments of the inversion are shown. The methods can adapt any public-domain available or other commercially-available industry-standard approaches. The methods can be integrated with methods, systems and/or applications supplied by third-party vendors or custom-developed within organizations. This invention may, however, be embodied in many different forms and should not be construed as limited to the illustrated embodiments set forth herein; rather, these embodiments are provided so that this disclosure will be thorough and complete, and will fully convey the scope of the invention to these skilled in the art. Like numbers refer to like elements throughout.

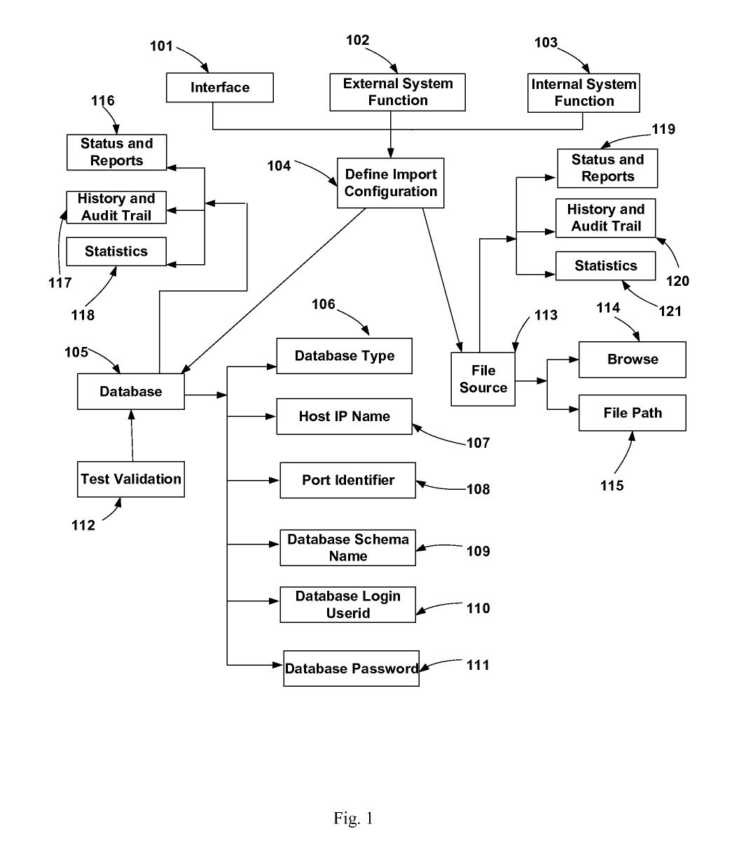

FIG. 1 describes a method to configure a database from within the system or that belongs to another system from where the data is imported. The data sources can be an external interface 101, any external system and its functions 102 or any internal system and its functions 103. The import mode 104 is configured through a Graphical User Interface (GUI) to receive data from a database 105 as well as a file source 113. The database source can be a schema from an external system interface or within the host system itself and its connection parameters values can be entered via the GUI. These are Database Type 106, Host IP Name 107, Port Identified 108, Database Schema Name 109, Database Login User 110 and Database Password 111. The method enables instantaneous validation of the connectivity by enabling user to select Test Validation 112 selection. For data loaded through a file, the GUI enables user to select the source File Path 115 and Browse 114 folders on the host or external system to select the file to load the data from. Information related to Status and Reports 116, 119, History Trail and Audit 117, 120 and Statistics 118, 121 for the database and file source respectively is tracked, maintained and linked to each imported data load. This information can be produced in any statistical, graphical or textual format.

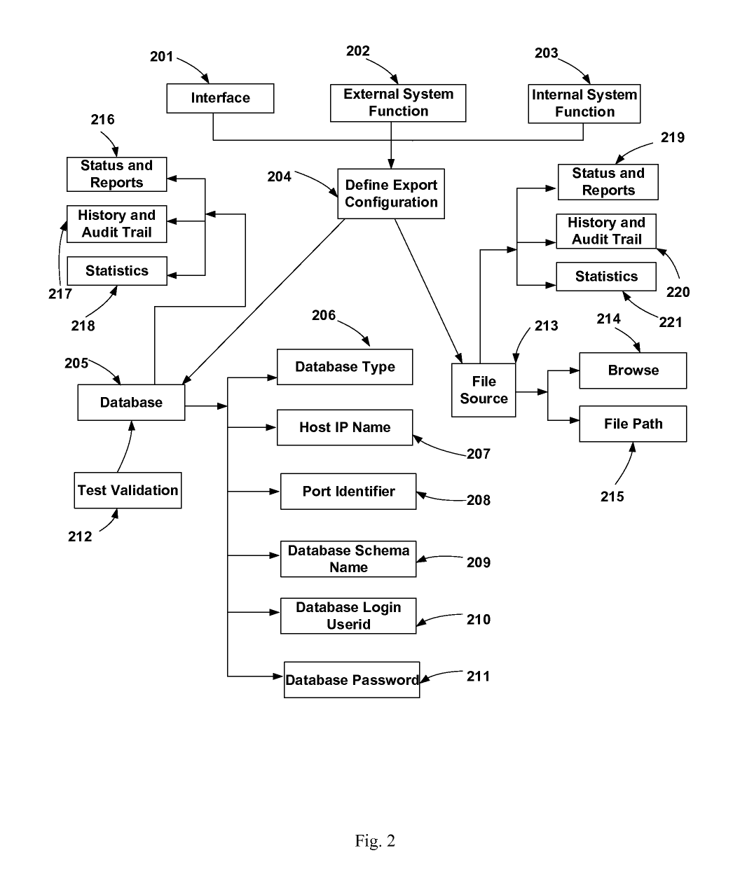

FIG. 2 describes a method to configure a database from within the system or that belongs to another system to which the data is exported. The data destination can be an external interface 201, a function of an external system 202 or the host system's function 203. The export mode 204 is configured through a Graphical User Interface (GUI) to send data to a database 205 as well as a file 213. The database source can be a schema from an external system interface or within the host system itself and its connection parameters values can be entered via the GUI. These are Database Type 206, Host IP Name 207, Port Identified 208, Database Schema Name 209, Database Login User 210 and Database Password 211. The method enables instantaneous validation of the connectivity by enabling user to select Test Validation 212 selection. For data to load to a file, the GUI enables user to select the destination File Path 215 and Browse 214 folders on the host or external system to load the data to. Information related to Status and Reports 216, 219, History Trail and Audit 217, 220 and Statistics 218, 221 for the database and destination source respectively is tracked, maintained and linked to each exported data load. This information can be produced in any statistical, graphical or textual format.

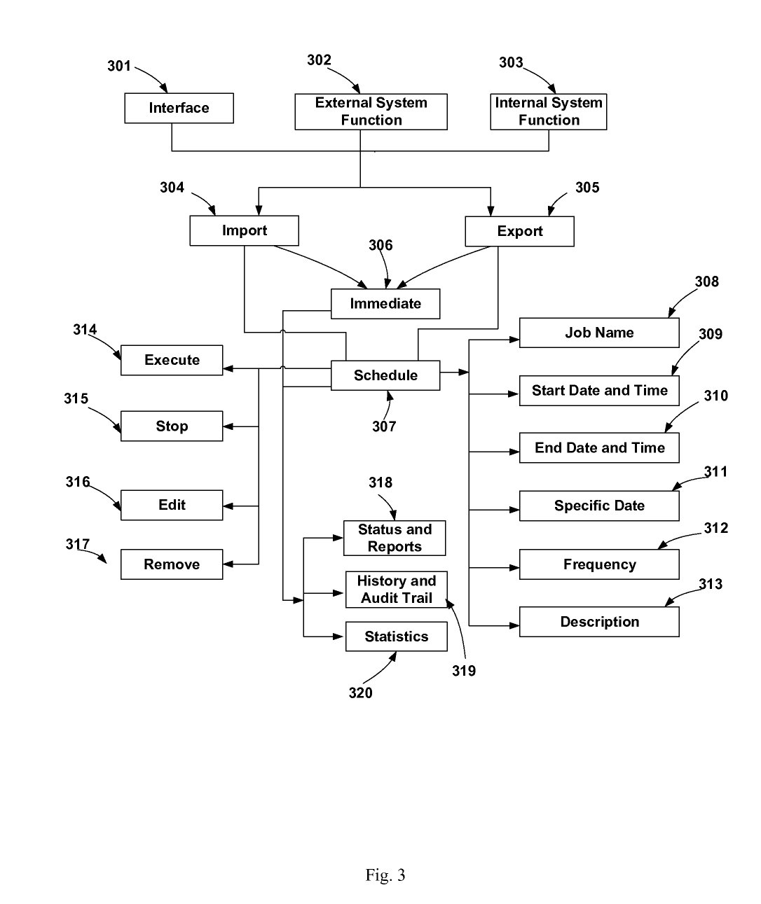

FIG. 3 describes a method to import and export data via GUI based configuration. Data can be received from an interface 301, a function of an external system 302 or within the host system function 303. The GUI enables both Import 304 and Export 305 configuration. For either, the data is loaded on an ad hoc basis referenced as Immediate 306 as well as by scheduling 307 a job 308 with start 309 and end 310 dates for recurring executions, a specific date and time 311 for a one time execution, frequency 312 and how often to import and export data recurrent or one time basis, with description 313 to contain user notes. The GUI enables a scheduled to be executed 314, an executed job to stop 315, edit 316 the schedule configuration or remove 317 the scheduled job. Information pertaining to Status and Reports 318, History Trail and Audit 319, and Statistics 320 is tracked, maintained and can be linked to the immediate ad hoc as well as scheduled import/export data loads. This information can be produced in any statistical, graphical or textual format.

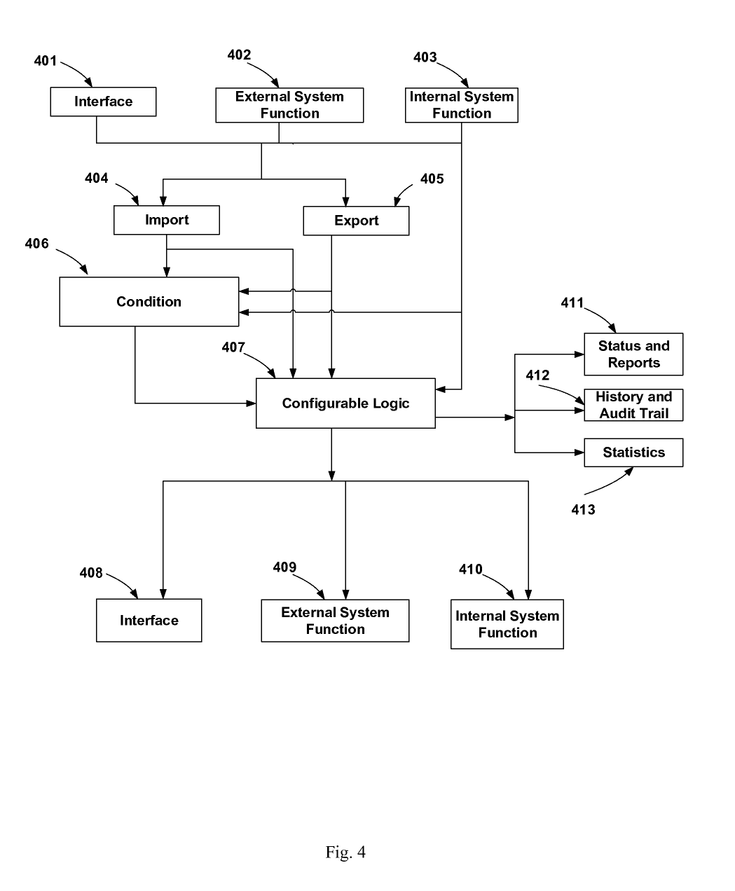

FIG. 4 describes a method to apply logic manipulation through a GUI. The data can flow from an interface 401, a function of an external system 402 or within the host system's function 403. The GUI enables configuration of both Import 404 and Export 405 of data. Any number of field attributes of the data can be set to have a condition 406 (such as having “null” value, or “Greater than”, “less than”, or range of values, if the same attribute exists in multiple systems or functions, then perform an n-way match where n is the number of systems the user will want to perform a match against) specified through the GUI. Through the GUI, the Configurable Logic 407 enables setting up rule(s) to derive new values for any attribute of the data that can be linked to a condition or without a condition. Once the logic manipulation rule is set, it can be enabled so that every future load of the data will be subjected to that rule with the ability for exclusion, and new values derived based on the rule(s) and condition(s) set. The rules can also be executed against already loaded data. The new values can replace the original values or can co-exist with the original values. New values can also be created also for a new attribute that does not exist in the original data. Multiple rules can be created to derive different sets of data for different attributes. The new set of data that can include a mix of new and derived values is then enabled for the interface 408, external system function 409 or internal system function 410 to receive it. Information related to Status and Reports 411, History Trail and Audit 412, and Statistics 413 is tracked, maintained and linked to value that was modified and by who or what. This information can be produced in any statistical, graphical or textual format.

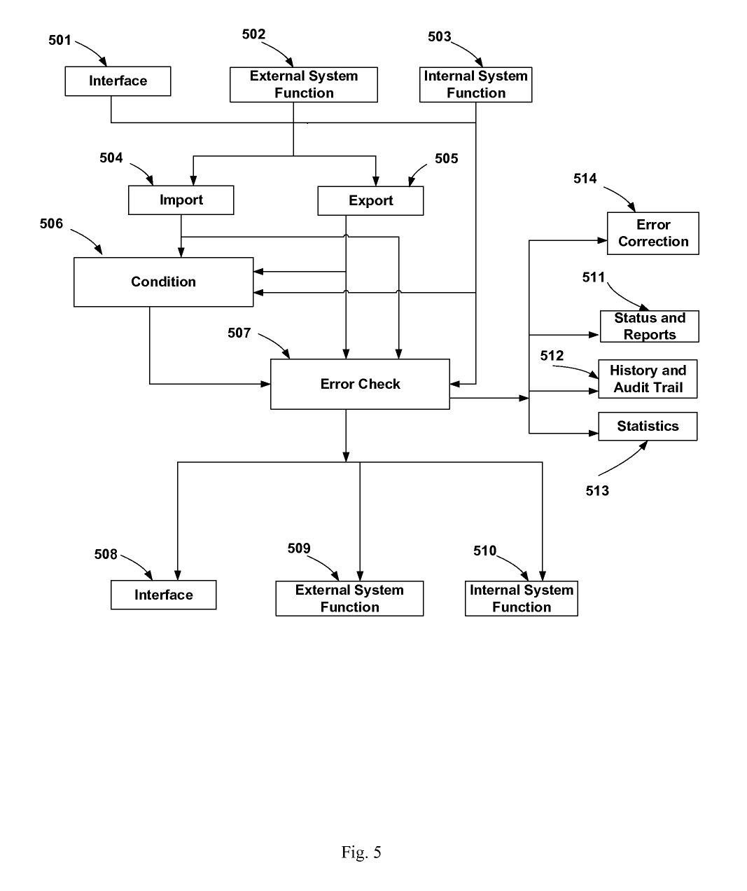

FIG. 5 describes a method to apply error checking through a GUI. The data can flow from an interface 501, a function of an external system 502 or within the host system's function 503. The GUI enables ability to configure both Import 504 and Export 505 of data. Any number of field attributes of the data can be set to have a condition 506 (such as having “null” value, or “Greater than”, “less than”, or range of values, if the same attribute exists in multiple systems or functions, then perform an n-way match where n is the number of systems the user will want to perform a match against) specified through the GUI. Through GUI, Error Correction 514 can be set so that the data that meets the error check condition is subjected to the correction that is established, such as send out notification to someone, modify a parameter with a new value, update source and destination systems. The error checking can be linked to a condition. Once the error check and correction rule is set, it can be enabled so that every future load of the data is subjected to that rule with the ability for exclusion, and new values or correction derived based on the rule(s) and condition(s) set. The rules can also be executed against already loaded data. The new values can replace the original values or can co-exist with the original values. New values can also be created also for a new attribute that does not exist in the original data. Multiple rules can be created to derive different sets of data for different attributes. The new set of data that can include a mix of new and derived values is then enabled for the interface 508, external system function 509 or internal system function 510 to receive it. Information related to Status and Reports 511, History Trail and Audit 512, and Statistics 513 is tracked, maintained and linked to value that was modified and by who or what. This information can be produced in any statistical, graphical or textual format.

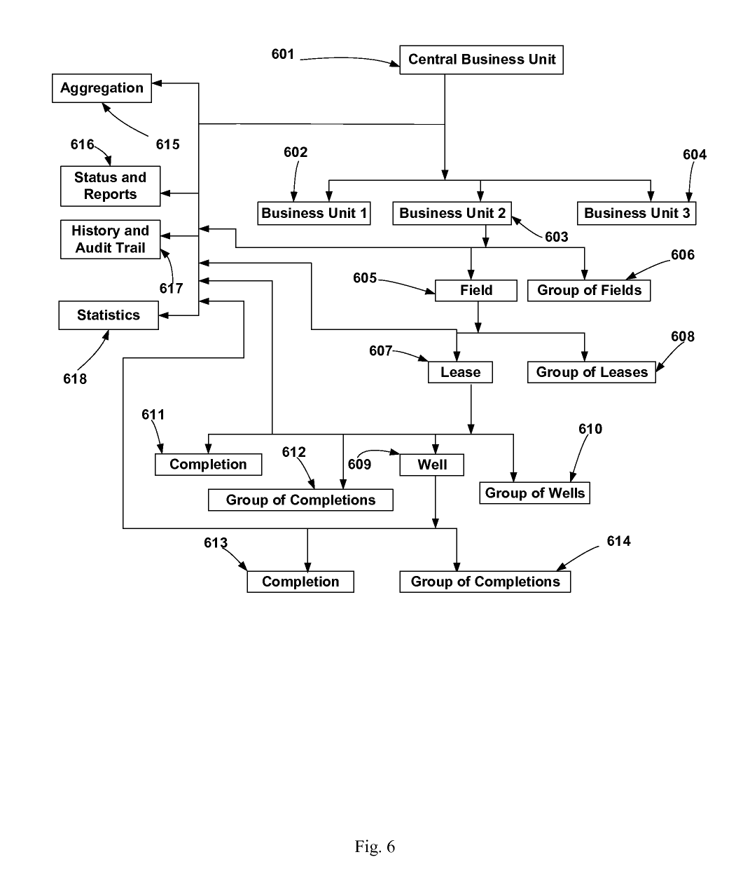

FIG. 6 describes a method to create a hierarchical structure that enables tracking and data flow of reserves information in a way values can be rolled up or rolled down, (that is, broken down) as a user traverses up and down the hierarchy tree through a GUI. The node 601 can be organized so that it is a highest parent node that owns all the entities of the nodes that branch out below it. Children nodes 602, 603, 604 can be sub business units each of which can support field-level 605 assets or group of fields 606. Its asset can be grouped into lease 607 or group of leases 608. A lease can physically own an asset in on or under the group or subsea.

Each lease node can have its asset divided across a well 609, group of wells, 610, a completion 611 or a group of completions 612. A well can provide further nested asset granularity by managing a completion 613 or a group of completions 614 asset nodes. Any value or information can roll up, or rolled down, that is, broken down, from any level of hierarchy. The roll up, roll down values can be based on any arithmetic and/or Boolean logic criteria, and an aggregation 615 can be obtained at each parent node. Information related to Status and Reports 616, History Trail and Audit 617, and Statistics 618 is tracked, maintained and linked to value that was modified and by who or what. This information can be produced in any statistical, graphical or textual format.

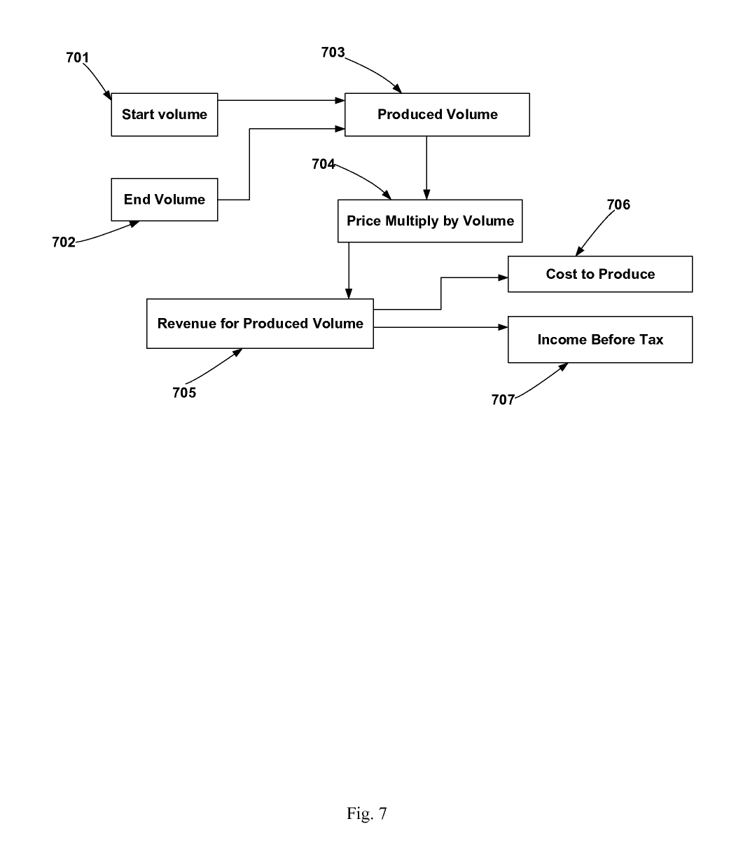

FIG. 7 describes a method to derive available versus used volume of a reserves commodity. A difference 703 between the Start Volume 701 and End Volume 702 will provide the asset volume that was produced. The revenue 705 for the volume produced is derived by multiplying the produced volume with the price 704. The cost of producing 706 is subtracted from the revenue to generate the Before Tax Income 707. This calculation enables asset availability, asset used, production cost, revenue and income to be generated at each asset node in a hierarchy. Each value is then rolled up or down to provide a higher level aggregation or a lower level break down. A new value can be entered replacing the old value by either a user entering this new value in the GUI or is applied through the logic manipulation method. Each node provides an aggregation that is based on the algorithmic rule of its children asset nodes. The final reserves numbers represented by the reserves data 708 that can be used for regulatory reporting and the related financial reports represented by the financial data 709 can be obtained at any asset node in the hierarchy. Information related to status and reports, audit trail and history, and statistics is tracked, maintained and linked to each element of the asset. This information can be produced in any statistical, graphical or textual format.

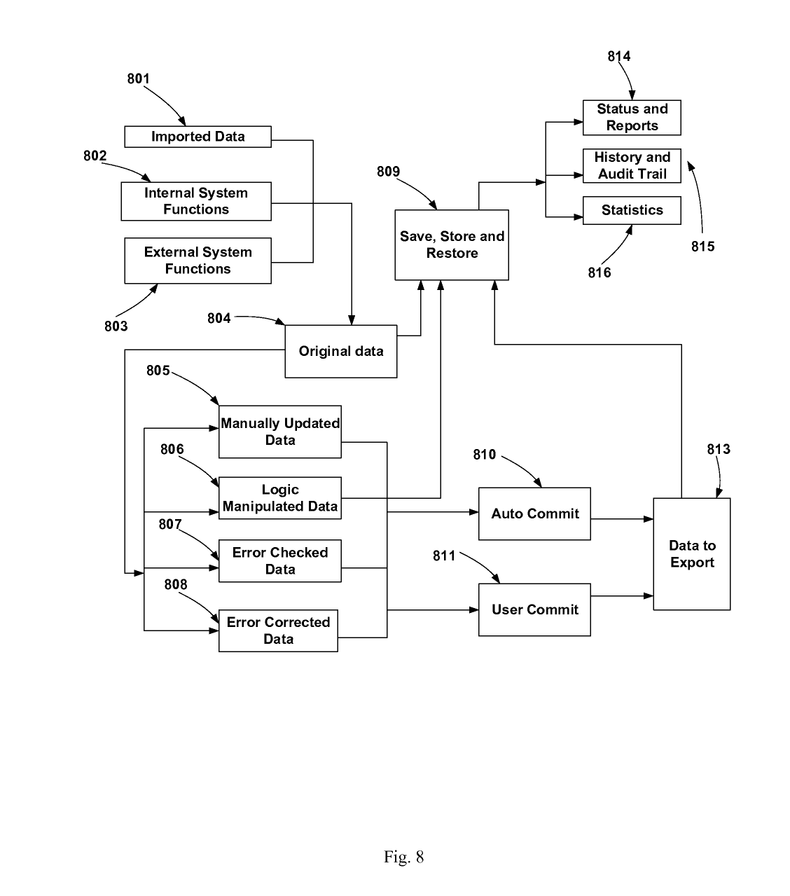

FIG. 8 describes a method to manage data mining by tracking the original values and any derived or modified values of the incoming and outgoing data. The data can be imported 801 or received from a function of an external system 802 or from within the host system's function 803. The original data 804 is time-stamped and stored and/or archived 809. The original can be subjected to a person manually updating 805 the data, modifications through the Logic Manipulation 806 method and/or modifications as a result of Error-Check method 807, 808. The data can then be subjected to either Auto Commit 810 flow which transfers it directly to the export module 813 or User Commit flow 811 that enables a person to control its flow through the GUI. The data from the Export module 813 can then be propagated to the receiving system, function or interface. The original and modified data is saved and stored 809 in the system or in an archive facility, and any or all information can be reproduced any time in the future with the history and audit trail. Information related to Status and Reports 814, History Trail and Audit, 815 and Statistics 816 is tracked, maintained and linked to each element of the asset. This information can be produced in any statistical, graphical or textual format.

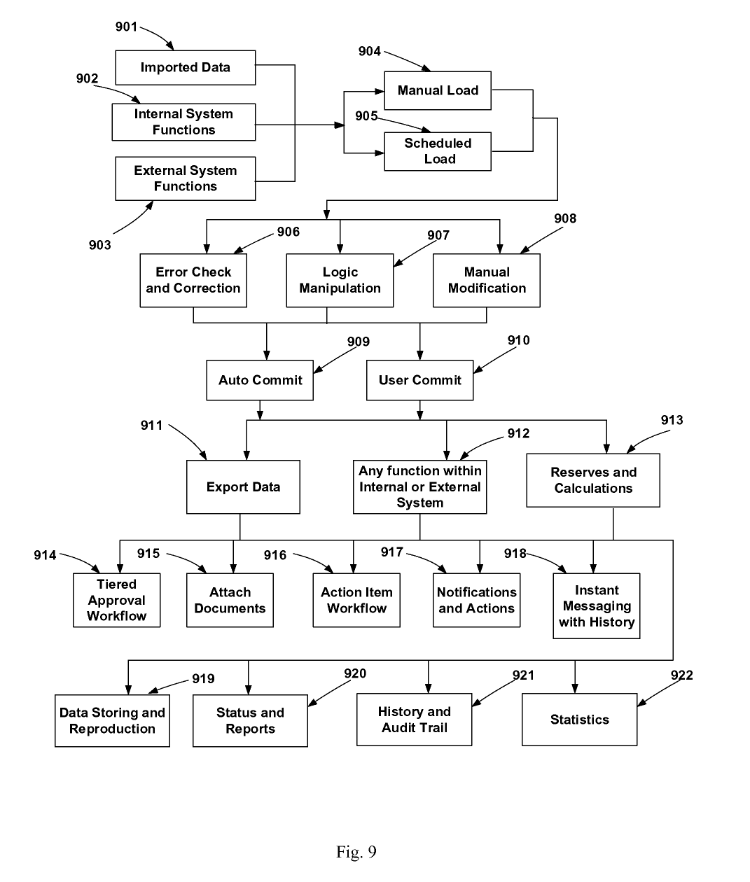

FIG. 9 describes a method to manage a variation of import data, loading means applying error check, logic manipulation and/or user modification, enabling direct auto commit or user controlled commit flow of data, managing roll up and roll down calculations, and data mining by storing and reproducing data in conjunction with approval, document attachment, action item workflow, notification and related actions and instant messaging, all from within one single system or spread across multiple systems. The data can be imported 901 or received from a function of an external system 902 or from within the host system's function 903. The load can occur manually 904 or scheduled 905 with recurring frequency and timing. The loaded data can be subjected to pre-set rules of error check with correction 906 with or without conditions, logic manipulation 907 with or without conditions, and/or manual modification 908 by a person through a GUI. The mix of original and modified data can be transported directly to the receiving systems 911, 912, 913 through Auto Commit 909, functions and interfaces, or can be controlled through User Commit 910 flow where a person manually can release the data to export. The functions that use this data can enable a tiered approval workflow 914, document attachment 915, action item workflow 916, notifications and related actions 917, and instant messaging 918. The original and modified data can be stored 919 in the system or an archiving facility, and produce the data any time in the future with history, audit trail and other supporting details. Information related to Status and Reports 920, History Trail and Audit, 921 and Statistics 922 is tracked, maintained and linked to each element of the asset. This information can be produced in any statistical, graphical or textual format.

Having described the invention above, various modifications in architecture, programming, steps and presentation will be apparent to those skilled in the art. It is intended that all such variations within the scope and spirit of the invention be included within the scope of the appended claims.

It is important to note that while embodiments of the present invention have been described in the context of a fully functional system and method embodying the invention, those skilled in the art will appreciate that the mechanism of the present invention on and/or aspects thereof are capable of being distributed in the form of a computer readable or writable medium of instructions in a variety of forms for execution on a process, processors, or the like.

What is claimed is:

1. A computer implemented method for the management of divisional entities and extremely large programs and projects comprising:
building a nested hierarchy of nodes representing multiple logical and geographic partitions of a local or global divisional Enterprise or Government entity, and the mega-programs and mega-projects that can span several of those partitions, navigating the hierarchy from a top node or major node, which represents a mega-program, all the way down to the nodes representing division departments and projects, their activities, resources and assets allows real-time access to and step-up or step-down through each node's status information including status report, summary, and key performance indicators;
collaboratively invoking business functions, wherein the business functions are Program, Project and Portfolio Management, Resource Capacity Management, Asset Tracking and Scheduling, Reserves Management, Budget and Financial Management, On-Call Management, Vendor Relations Management, Issue/Risk Management, and Change Management) and assist/support functions, wherein the assist/support functions are Modification Audit Trail, History, Business Considerations, Dependencies, Status Reports, Approvals, Action Items, Attachments, and Meetings) at any node, establishing that node as the context for the current user-requested operation, that is, any function invoked at any source node (or other point) will retain its relevant information at the source, localizing the information that can be accessed directly from the source;
supporting bi-directional flow of information, with access to the information of the paired nodes from either end, with controls at each node to enable summarization or expansion of information, and automated or manual updates with override ability;
allowing multiple users to create, view, update and delete-any object and all pertinent information in the said hierarchy collaboratively and interactively;
enabling the implementation and tracking of various business processes, workflows, and condition and threshold based triggers;
further enabling the implementation and following of government, industry standard or organization-customized business, operation or administrative structure, involving several levels of nesting to capture the complexity of certain standard structures, and further enabling the invocation of access, display, updating and other actions from any selected node in the hierarchy;
allowing the recording, monitoring and auditing of all business considerations, including security and compliance governance, such business considerations and their supporting details involving several levels of nesting to capture the complexity of some considerations, further enabling the linking of these considerations to any node in the hierarchy, and tracking collaboratively their related information and attachments, including status information within the context of each invoking node or other invoking points;
storing related data elements of the method in one or more databases;
allowing the said hierarchy and the said business and assist functions to operate in one integrated, all-encompassing method that can be invoked from every node while localizing the pertinent information at the invoking node;
real-time updating and viewing of the status information of all nodes in the said hierarchy by multiple users collaboratively and by processor according to specific criteria including time or schedule, business criticality, complexity, risk, and compliance requirements depicted in statistical, graphical, and visual flag formats, enabling intelligence progress management that accounts for the said criteria in addition to traditional criteria such as the numbers of tasks completed and tasks remaining relative to the total number of tasks and elapsed time relative to allocated time;
computing the completion percentage at a node representing an activity such as a task, project, program and mega-program as a weighted average of the completion percentages of their child nodes, the weight factors being user-specified or system-computed;
assigning severity or priority levels to the said criteria such as business importance criticality, complexity and risk, high weight factors being typically assigned to high severity or priority levels, emphasizing the completion of high severity or high priority activities and de-emphasizing the completion of simple, low severity or priority activities in the overall computed completion percentage;
carrying out the computation of completed percentages automatically up the hierarchy all the way from the bottom leaf nodes to the highest owning node, the values of the sibling nodes being averaged through computation and the resulting value being propagated to the parent node, and assigned to it;
providing the option to manually override the automatic progression of information with user-defined information at each node, which is in turn used for computation to derive the resulting value that is propagated upwards to its parent node;
mapping the method and user definable values of the input criteria for weight, importance criticality, complexity and risk through arrays or matrices;
controlling the flow of information from sibling nodes to parent nodes to be automatic, manual or through other defined criteria;
supporting interactive collaboration and the use of assist and business functions with the pertinent information localized at the invoking source;
providing summarized information that includes progress, warning flags that enable hyper-link access to the source of the information;
enabling condition and threshold based triggering of actions across nodes, assist/business functions, and external systems;
notifying proactively users who are involved at a given node of the said hierarchy whenever the actual progress corresponding to that node falls behind the computed expected progress;
providing notification methods that include colored and flashing visual flags combined with verbiage in the user interface depending on the severity of the delays, text and email messages, for instance, a yellow flag is issued if the remaining time is less than the time allocated to remaining tasks, but if this situation remains unchanged and the remaining time reached a next threshold, then the flag turns red, and if the deadline is reached prior to completing the activity, then the red flag starts flashing with a display of the computed delay;
propagating progress and notification indicators upward throughout the hierarchy automatically, computing the resulting status indicator at each node from the status indicators of its child nodes using or not using automated or manually defined logic, Boolean and arithmetic expressions;
providing the option of overriding the received information at any node from its child nodes with user-specified values and status indicators, computing new values in conjunction with subordinate child nodes and propagating the resulting value up to the parent node;
providing display and update access to each node's and its immediate child nodes' information including details, summaries and graphical representations;
enabling upward and downward navigation from a node indicating the presence of exceptions or issues to the dependent nodes where the exceptions originated, allowing for quick root cause analysis;
controlling the flow of information from sibling nodes to parent nodes to be automatic, manual or through other defined criteria;
supporting interactive collaboration and the use of assist and business functions with the pertinent information localized at the invoking source;
providing summarized information that includes progress, warning flags that enable hyper-link access to the source of the information;
enabling condition and threshold based triggering of actions across nodes, assist/business functions, and external systems;
generating reports that can provide any information from any node of the said hierarchy, a collection of such nodes, and any of the assist and business functions;
accessing assist functions, such as Attachments, from the context of the report;
presenting real-time and static information in any format, including statistical and graphical tables and charts;
hyperlinking thee values and fields displayed in the reports to provide direct access to the source of the information and enable creation, modification, deletion and other operations on the values reported;
consolidating reports and making them securely accessible, downloadable and printable from a central location;
maintaining history of reports for audit or other purposes;
providing the necessary information in real-time to every functional, technical and management layer, consolidating and/or summarizing the data at each level up, all the way into executive reports for the company's executives (and parent company, in the case of multiple subsidiaries);
enabling through a workflow interactive collaboration between people, systems and processes;
generating Look Ahead reports which are interactive reports that can be invoked from any node to compile proactive views of upcoming activities by specific time duration or future trends, allowing for adjustments of current plans to prevent problems such as delays and run-away budgets; and
enabling condition and threshold based triggering of actions across nodes, assist/business functions, and external systems, including alerts and warning flags.

2. The method of claim 1, further comprising Configurable Integration with external systems and applications and Data Mining, the method comprising the steps of:
interfacing with an external system or application by connecting and accessing its databases, files, file transfer protocol sites, or other data storing mechanism;
loading data with automated or manual checking of the data being loaded for errors utilizing one or more logical expressions;
specifying one or more actions to resolve each error, including ignoring the error, acknowledging and logging the error in the audit trail, accepting the error data with no changes, modifying and accepting the error data, rejecting the error data, deleting the error data, enabling contextual documentation, enabling approval workflow, enabling action item and attaching file;
reproducing the error history, audit trail reporting, contextual documentation, approval workflow history, action item history and attached file;
updating the data during the loading phase automatically utilizing one or more logic and arithmetic data manipulation expressions;
enabling the loaded data to be modified manually or through applying logic and arithmetic data manipulation expressions, acknowledging and logging the expression and data modification in the audit trail, accepting the data modification, enabling contextual documentation, enabling approval workflow, enabling action item and attaching file;
enabling the loaded data, modified or not, to be examined, re-modified and locked from further modifications;
accumulating, aggregating and storing the loaded data from a single or across multiple source systems or applications utilizing user specified logic and arithmetic data manipulation expressions;
releasing data, loaded from an external system or internally generated, modified or not modified, and making it available to the internal business functions or to be exported to an external system or application;
connecting and transferring the released data to the database, file, file transfer protocol site or other data storing mechanism of an external system or application, or allowing the external system or application to connect and load the released data;
enabling the user to invoke one or more steps of this method in an ad-hoc manner or by scheduling the invocation;
producing statistical and graphical reports from the history log; and
producing statistical and graphical reports on the history log.

3. The method of claim 1, further comprising Modification Audit Trail, which is an assist function comprising the steps of:
logging and storing all information that pertain to any data update event including the name and location of the updated data, old value, new value, the user who performed the update and the date and time when the update occurred;
enabling contextual documentation, approval workflow, action item and attaching file;
reproducing the audit trail based on criteria including changes to a particular set of data, changes made by a particular user and changes made during a particular time frame;
archiving the audit trail for a period of time;
reproducing the archived audit trail;
purging the audit trail based on a variety of criteria including time based and space based criteria;
producing statistical and graphical reports from the audit trail; and
producing statistical and graphical reports on the audit trail.

4. The method of claim 1, further comprising History, which is an assist function comprising the steps of:
logging and storing all information that pertain to the invocation of data import, data export, business and assist functions, the information including the name of the function invoked, the name and location of the data involved, the user who invoked the function, the completion status of the function, start date and time and duration;
enabling contextual documentation, approval workflow, action item and attaching file;
reproducing the history log based on criteria including the invocation of a particular function, invocations by a particular user and invocations made during a particular time frame;
archiving the history log for a period of time;
reproducing the archived history log;
purging the history log based on a variety of criteria including time based and space based criteria;
producing statistical and graphical reports from the history log; and
producing statistical and graphical reports on the history log.

5. The method of claim 1, further comprising Reserves Management, which is a business function comprising the steps of:
creating the hierarchy that represents the structure and information of the reserves assets and commodities;
updating and computing aggregations of reserves quantities including volumes, monetary values across assets and commodities up and down the hierarchy;
splitting a reserves quantity at a parent node and distributing it into its child nodes based on user specified division and distribution criteria; excluding an asset by removing its reserves quantities including volumes, monetary values across assets and commodities up and down the hierarchy;
including an asset by adding its reserves quantities including volumes, monetary values across assets and commodities up and down the hierarchy;
saving the modifications to the reserves data;
seeking approval for the modification performed;
accepting and releasing the modified reserves data;
preparing official reports against the released reserves data;
preparing financial reports against the released reserves data;
producing statistical and graphical reports from the history log; and
producing statistical and graphical reports on the history log.

6. A computer implemented system for the management of divisional entities and extremely large programs and projects, the computer implemented system comprising of:
a computer;
a software program stored on a computer wherein the software program is adapted to:
building a nested hierarchy of nodes representing multiple logical and geographic partitions of a local or global divisional Enterprise or Government entity, and wherein the mega-programs and mega-projects that can span several of those partitions. Navigating the hierarchy from a top node or major node, which represents a mega-program, all the way down to the nodes representing division departments and projects, their activities, resources and assets allows real-time access to and step-up or step-down through each node's status information including status report, summary, and key performance indicators;
collaboratively invoking business functions, wherein the business functions are Program, Project and Portfolio Management, Resource Capacity Management, Asset Tracking and Scheduling, Reserves Management, Budget and Financial Management, On-Call Management, Vendor Relations Management, Issue/Risk Management, and Change Management) and assist/support functions, wherein the assist/support functions are Modification Audit Trail, History, Business Considerations, Dependencies, Status Reports, Approvals, Action Items, Attachments, and Meetings) at any node, establishing that node as the context for the current user-requested operation, that is, any function invoked at any source node (or other point) will retain its relevant information at the source, localizing the information that can be accessed directly from the source;
supporting bi-directional flow of information, with access to the information of the paired nodes from either end, with controls at each node to enable summarization or expansion of information, and automated or manual updates with override ability;
allowing multiple users to create, view, update and delete any object and all pertinent information in the said hierarchy collaboratively and interactively;
enabling the implementation and tracking of various business processes, workflows, and condition and threshold based triggers;
further enabling the implementation and following of any of the pertinent government, industry standard or organization-customized business, operation or administrative structure, involving several levels of nesting to capture the complexity of certain standard structures; and
further enabling the invocation of access, display, updating and other actions from any selected node in the hierarchy;
allowing the recording, monitoring and auditing of all business considerations, including security and compliance governance, such business considerations and their supporting details involving several levels of nesting to capture the complexity of some considerations, further enabling the linking of these considerations to any node in the hierarchy, and tracking collaboratively their related information and attachments, including status information within the context of each invoking node or other invoking points;
storing related data elements of the method in one or more databases;
allowing the said hierarchy and the said business and assist functions to operate in one integrated, all-encompassing method that can be invoked from every node while localizing the pertinent information at the invoking node;
real-time updating and viewing of the status information of all nodes in the said hierarchy by multiple users collaboratively and by processor according to specific criteria including time or schedule, business criticality, complexity, risk, and compliance requirements depicted in statistical, graphical, and visual flag formats, enabling intelligence progress management that accounts for the said criteria in addition to traditional criteria such as the numbers of tasks completed and tasks remaining relative to the total number of tasks and elapsed time relative to allocated time;
computing the completion percentage at a node representing an activity such as a task, project, program and mega-program as a weighted average of the completion percentages of their child nodes, the weight factors being user-specified or system-computed;
assigning severity or priority levels to the said criteria such as business importance criticality, complexity and risk, high weight factors being typically assigned to high severity or priority levels, emphasizing the completion of high severity or high priority activities and de-emphasizing the completion of simple, low severity or priority activities in the overall computed completion percentage;
carrying out the computation of completed percentages automatically up the hierarchy all the way from the bottom leaf nodes to the highest owning node, the values of the sibling nodes being averaged through computation and the resulting value being propagated to the parent node, and assigned to it;
providing the option to manually override the automatic progression of information with user-defined information at each node, which is in turn used for computation to derive the resulting value that is propagated upwards to its parent node;
mapping the method and user definable values of the input criteria for weight, importance criticality, complexity and risk through arrays or matrices;
controlling the flow of information from sibling nodes to parent nodes to be automatic, manual or through other defined criteria;
supporting interactive collaboration and the use of assist and business functions with the pertinent information localized at the invoking source;
providing summarized information that includes progress, warning flags that enable hyper-link access to the source of the information;
enabling condition and threshold based triggering of actions across nodes, assist/business functions, and external systems;
notifying proactively users who are involved at a given node of the said hierarchy whenever the actual progress corresponding to that node falls behind the computed expected progress;
providing notification methods that include colored and flashing visual flags combined with verbiage in the user interface depending on the severity of the delays, text and email messages, for instance, a yellow flag is issued if the remaining time is less than the time allocated to remaining tasks, but if this situation remains unchanged and the remaining time reached a next threshold, then the flag turns red, and if the deadline is reached prior to completing the activity, then the red flag starts flashing with a display of the computed delay;
propagating progress and notification indicators upward throughout the hierarchy automatically, computing the resulting status indicator at each node from the status indicators of its child nodes using or not using automated or manually defined logic, Boolean and arithmetic expressions;
providing the option of overriding the received information at any node from its child nodes with user-specified values and status indicators, computing new values in conjunction with subordinate child nodes and propagating the resulting value up to the parent node;
providing display and update access to each node's and its immediate child nodes' information including details, summaries and graphical representations;
enabling upward and downward navigation from a node indicating the presence of exceptions or issues to the dependent nodes where the exceptions originated, allowing for quick root cause analysis;
controlling the flow of information from sibling nodes to parent nodes to be automatic, manual or through other defined criteria;
supporting interactive collaboration and the use of assist and business functions with the pertinent information localized at the invoking source;
providing summarized information that includes progress, warning flags that enable hyper-link access to the source of the information;
enabling condition and threshold based triggering of actions across nodes, assist/business functions, and external systems;
generating reports that can provide any information from any node of the said hierarchy, a collection of such nodes, and any of the assist and business functions;
accessing assist functions, such as Attachments, from the context of the report;
presenting real-time and static information in any format, including statistical and graphical tables and charts;
hyperlinking thee values and fields displayed in the reports to provide direct access to the source of the information and enable creation, modification, deletion and other operations on the values reported;
consolidating reports and making them securely accessible, downloadable and printable from a central location;
maintaining history of reports for audit or other purposes;
providing the necessary information in real-time to every functional, technical and management layer, consolidating and/or summarizing the data at each level up, all the way into executive reports for the company's executives (and parent company, in the case of multiple subsidiaries);
enabling through a workflow interactive collaboration between people, systems and processes;
generating Look Ahead reports which are interactive reports that can be invoked from any node to compile proactive views of upcoming activities by specific time duration or future trends, allowing for adjustments of current plans to prevent problems such as delays and run-away budgets; and
enabling condition and threshold based triggering of actions across nodes, assist/business functions, and external systems, including alerts and warning flags.
